(19) United States
(12) Patent Application Publication
(10) Pub. No.: US 2026/0303442 A1
(43) Pub. Date: Oct. 1, 2026

(54) Client Communication Resiliency

(71) Applicant: Bank of America Corporation, Charlotte, NC (US)

(72) Inventors: Steven E. Sinks, Scottsdale, AZ (US); Joshua Abraham, Sharon, MA (US)

(21) Appl. No.: 19/093,548

(22) Filed: Mar. 28, 2025

(51) Int. Cl. H04L 41/0663; H04L 43/16; H04L 67/1021

(52) U.S. Cl. CPC H04L 41/0663; H04L 43/16; H04L 67/1021

(57) ABSTRACT

Arrangements for providing resilient communications to client applications are provided. A computing platform may attempt to establish communication with a first server location of a first server set. If the attempt fails, the platform may determine whether additional server locations in the first server set are available. If so, the platform may identify a second server location of the first server set and may attempt to establish communication. If no additional server locations are available in the first server set, the platform may identify a server location in a second server set and may attempt to establish communication with the server location of the second server set. The platform may generate a notification indicating that communication has been attempted with the server location in the second server set and providing an option to create additional server locations. The notification may be transmitted to and displayed by an enterprise computing device.

### BACKGROUND

Aspects of the disclosure relate to electrical computers, systems, and devices for controlling one or more servers to improve application resiliency.

Traditional client communications are not resilient to failure. For instance, if a client application attempts to communicate with a server and fails, it may reattempt communication with the same server multiple times before finally failing. These situations lead to user frustration with an inability to connect. Conventional arrangements may use load balancing or other arrangements to improve resiliency. However, those arrangements are based on fixed resources and cannot be dynamically modified. Accordingly, it would be advantageous to provide dynamic server control to improve application resiliency.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical issues associated with providing resilient communications to client applications.

In some examples, a computing platform having at least one processor and memory may attempt to establish communication with a first server location of a first set of server locations. If the attempt to establish communication fails, the computing platform may determine whether additional server locations in the first set of server locations are available. If so, the computing platform may identify a second server location of the first set of server locations and may attempt to establish communication. If no additional server locations are available in the first set of server locations, the computing platform may identify a server location in a second set of server locations and may attempt to establish communication with the server location of the second set of server locations. Further, the computing platform may generate a notification indicating that communication has been attempted with the server location in the second set of server locations and providing an option to create additional server locations. The notification may be transmitted to an enterprise computing device and displayed by a display of the enterprise computing device.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for server control and communication resiliency in accordance with one or more aspects described herein;

FIGS. 2A-2F depict an illustrative event sequence for server control and communication resiliency in accordance with one or more aspects described herein;

FIG. 3 illustrates an illustrative method for server control and communication resiliency according to one or more aspects described herein;

FIG. 4 illustrates one example notification that may be generated in accordance with one or more aspects described herein; and

FIG. 5 illustrates one example environment in which various aspects of the disclosure may be implemented in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed above, traditional client communications are not resilient to failure. For instance, if a client application attempts to communicate with a server and fails (e.g., if the server is down, blocked, or the like), it may reattempt communication with the same server multiple times before finally failing. These situations lead to user frustration with an inability to connect. Accordingly, aspects described herein provide resilient communications by providing a plurality of server locations in a plurality of server sets. As issues arise preventing communication with a server location or server set, additional server locations may be generated or created in order to maintain communication.

For instance, when generating a client application, a set of different server locations for the client to communicate with may be created. This may provide an array of server locations for the client to communicate with in case of failure or issues with a particular server location. Accordingly, if attempted communication with a first server location of a first server set fails, a failure count associated with the first server location may be increased and the failure count may be compared to a failure count threshold. If the failure count is below the threshold, the first server location may be maintained in the first server set. If the failure count is at or above the threshold, the first server location may be removed from the first server set. The system may then determine whether additional server locations are available in the first server set. If so, the system may randomly select another server location of the first server set with which to attempt communication, the attempt may be executed and the process may continue.

If no additional server locations are available, communication may be attempted with a server location in a second server set. In addition, a notification indicating that communication with the second server set has been attempted and providing an option to create or generate additional server locations may be generated and transmitted to an enterprise computing device. Accordingly, additional server locations may be generated to ensure that communication is available and to avoid failures of communication.

These and various other arrangements will be discussed more fully below.

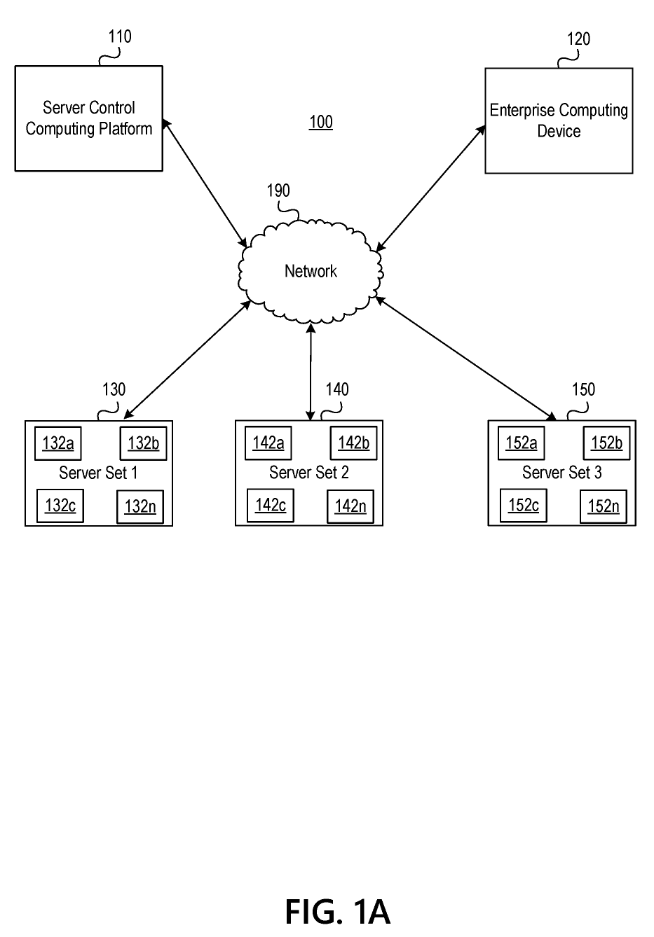

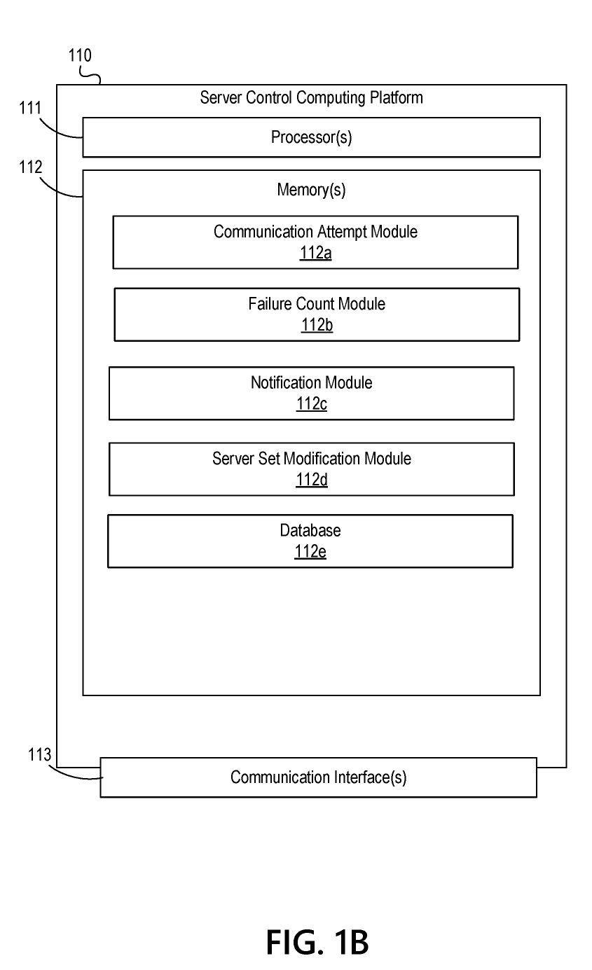

FIGS. 1A-1B depict an illustrative computing environment and devices for resilient client communications in accordance with one or more aspects described herein. Referring to FIG. 1A, computing environment 100 may include one or more computing devices and/or other computing systems. For example, computing environment 100 may include server control computing platform 110, enterprise computing device 120, server set 1 130, including a plurality of server locations 132a-132n, server set 2 140 including a plurality of server locations 142a-142n, and server set 3 150 including a plurality of server locations 152a-152n.

Although one enterprise computing device 120, three server sets 130, 140, 150 and four server locations within each server set are shown, any number of systems, devices or sets may be used without departing from the invention.

Server control computing platform 110 may be or include one or more computer components (e.g., servers, server blade, processor, memory, and the like) and may be configured to perform intelligent, dynamic, real-time control of servers and server locations in order to maintain client communications. For instance, server control computing platform 110 may attempt client communication with a particular server location within a first set of servers (e.g., server location 132a within server set 1 130). Server control computing platform 110 may monitor the attempted communication to determine whether it is successful. If so, communication with the particular server location (e.g., server locations 132a) within server set 1 130 may be initiated.

Alternatively, if the attempted communication fails (e.g., the particular server location is offline or there is another issue disrupting communication), server control computing platform 110 may increase a failure count associated with the particular server location (e.g., server locations 132a) in server set 1 130 and may compare the failure count to a failure threshold. If the failure count is below the threshold, the particular server location (e.g., server location 132a) in server set 1 130 may be maintained in the server set 130. If the failure count is at or above the threshold, the particular server location (e.g., server location 132a) may be removed from server set 1 130.

Server control computing platform 110 may, in response to the failed communication attempt, attempt the client communication with another server location within server set 1 130. In some examples, the other server location within server set 1 130 may be randomly selected by the server control computing platform 110. Accordingly, the other server location selected may be a same server location as the particular server location (e.g., server location 132a) attempted above, or may be a different server location (e.g., server location 132b, server location 132c, server location 132n) of a plurality of server locations within server set 1 130. If the attempted communication is successful, the client communication may be routed to the other server location of server set 1 130. If not, the failure count for the other server location may be increased and compared to the threshold, as discussed above.

This process may continue until no further server locations are available within server set 1 130. At that point, server control computing platform 110 may begin attempting communication with a first server location (e.g., server location 142a) within server set 2 140. In addition, server control computing platform 110 may generate and transmit a notification to enterprise computing device 120 indicating that no further locations are available in server set 1 130 and communication is being attempted with server set 2 140. In response to the notification, additional server locations may be added to server set 1 130 and/or additional sets of servers may be added to the system to accommodate for the loss of the server locations in server set 1 130. Accordingly, the process may always maintain a sufficient number of server locations in order to ensure communication is available.

The arrangements described herein are communication method agnostic and may be used with any type of communication (e.g., web based, VPN, SSH tunnel, or the like). The example arrangements described herein should not be viewed as limiting the arrangements to any particular method of communication and, instead, are merely examples.

In some examples, the additional server locations and/or sets may be established automatically by the server control computing platform 110. Additionally or alternatively, one or more users or administrators may provide input regarding additional server locations and/or sets.

Enterprise computing device 120 may be or include one or more computer components (e.g., servers, server blade, processor, memory) and/or computing devices (e.g., laptop computers, desktop computers, mobile devices, tablet devices, or the like) and may be configured to receive and display notifications related to server location availability, provide input regarding additional server locations and/or server sets, and the like. In some examples, enterprise computing device 120 may be an administrator computing device of the enterprise organization.

Server set 1 130, server set 2 140 and/or server set 3 150 may be or include one or more servers providing server locations (e.g., 132a-132n, 142a-142n, 152a-152n) for communication with one or more clients (e.g., applications, or the like). Each server set 130, 140, 150 may include a plurality of servers or server locations (e.g., server set 130 includes server locations 132a-132n, server set 2 140 includes server locations 142a-142n, server set 3 includes server locations 152aq-152n). In some examples, each server location may include a uniform resource locator (URL). Although three server sets are shown, any number of sets may be used and each server set may include a plurality of server locations, without departing from the invention. In some examples, each server set may have the same or different number of server locations.

As mentioned above, computing environment 100 also may include one or more networks, which may interconnect one or more of server control computing platform 110, enterprise computing device 120, server set 1 130, server set 2 140 and/or server set 3 150. For example, computing environment 100 may include network 190. Network 190 may, in some examples, be a private network and include one or more sub-networks (e.g., Local Area Networks (LANs), Wide Area Networks (WANs), or the like). In some examples, network 190 may be a public network or may include a public network and private network in communication with each other. Network 190 may interconnect one or more computing devices associated with the organization and/or external to the organization. For example, server control computing platform 110, enterprise computing device 120, server set 1 130, server set 2 140 and/or server set 3 150 may be connected via network 190.

Referring to FIG. 1B, server control computing platform 110 may include one or more processors 111, memory 112, and communication interface 113. A data bus may interconnect processor(s) 111, memory 112, and communication interface 113. Communication interface 113 may be a network interface configured to support communication between server control computing platform 110 and one or more networks (e.g., network 190, or the like). Memory 112 may include one or more program modules having instructions that when executed by processor(s) 111 cause server control computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of server control computing platform 110 and/or by different computing devices that may form and/or otherwise make up server control computing platform 110.

For example, memory 112 may have, store and/or include communication attempt module 112a. Communication attempt module 112a may store instructions and/or data that may cause or enable the server control computing platform 110 to attempt communication with various server locations within a server set. For instance, in some examples, communication attempt module 112a may attempt communication with a first, randomly selected server location within a first server set (e.g., one of 132a-132n in server set 1 130). If communication is successful, communication attempt module 112a may route communication from the client application to the server location. If communication is not successful, another server location (the same or another of server locations 132a-132n) may be randomly selected and communication attempted. If no additional server locations are available in server set 1 130, the communication attempt module 112a may attempt communication with a server location (e.g., one of 142a-142n) in server set 2 140, and the process may continue.

Server control computing platform 110 may further have, store and/or include failure count module 112b. Failure count module 112b may store instructions and/or data that may cause or enable the server control computing platform 110 to, upon a failed communication attempt with a particular server location, increase a failure count associated with that particular location. Failure count module 112b may store further instructions that may cause or enable the server control computing platform 110 to compare a current failure count for a particular server location to a threshold failure count. If the current failure count is below the threshold, the server location may remain active as part of the respective server set. If the current failure count meets or exceeds the threshold, the server location may be removed from the server set. Once there are no additional server locations remaining in a server set, communication attempt module 112a may attempt communication with server locations in a second server set (e.g., server set 2 140).

Server control computing platform 110 may further have, store and/or include notification module 112c. Notification module 112c may store instructions and/or data that may cause or enable the server control computing platform 110 to generate a notification indicating that no active server locations remain in a particular server set and that communication is being attempted with a second server set. The notification may be transmitted to, for instance, enterprise computing device 120, which may cause the notification to be displayed by a display of the enterprise computing device 120.

Server control computing platform 110 may further have, store and/or include server set modification module 112d. Server set modification module 112d may store instructions and/or data that may cause or enable the server control computing platform 110 to, in response to a notification that no server locations are available in a first server set 130 and communication is being attempted with a server location in another server set (e.g., server set 2 140) generate or create additional server locations in server set 1 130. For instance, if server set 1 130 originally includes three server locations, 132a, 132b, and 132c, additional server location 132n may be created to enable communication with the first server set 130 as issues impacting communication are addressed and thereby providing server set 2 140 and server set 3 as backup communication options. Although one new server location is described here, any number of additional server locations may be generated. Further, although the server locations are described as being added to server set 1 130, in some examples, a new server set may be generated that may include the newly created server locations. In some examples, additional server locations or server sets may be automatically generated by the server set modification module 112d. Additionally or alternatively, a user (e.g., a user associated with enterprise computing device 120) may cause generation of one or more additional server locations or server sets (e.g., in response to display of the notification).

Server control computing platform 110 may further have, store and/or include database 112e. Database 112e may store data associated with client applications, server locations, failure counts, failure count thresholds, and/or any other data to perform the functions of server control computing platform 110.

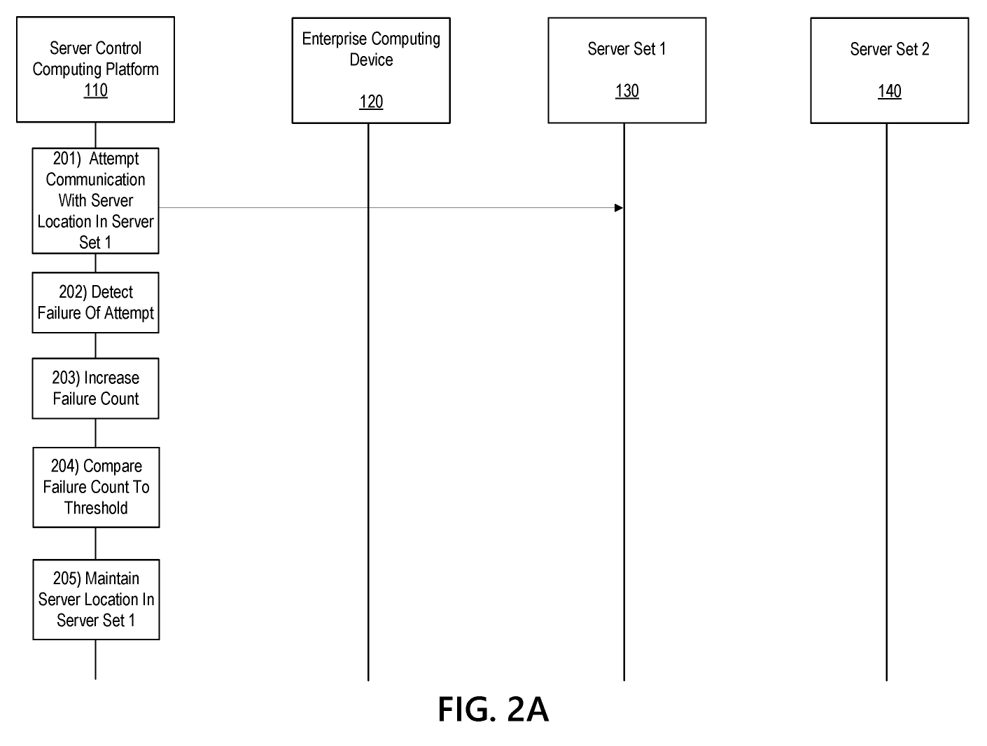

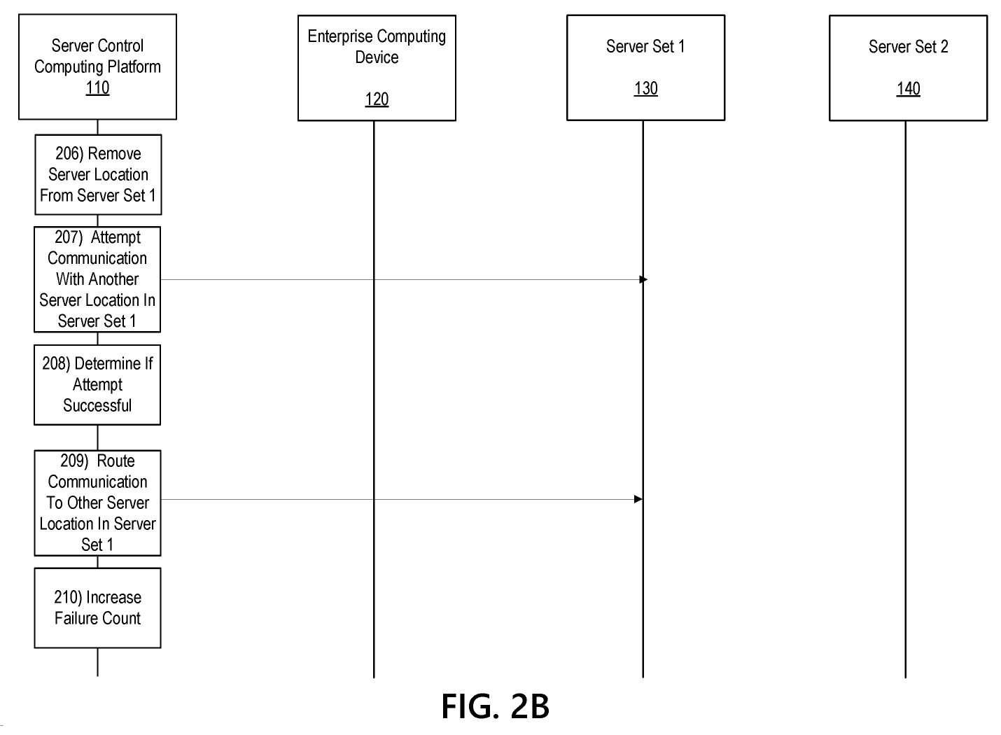

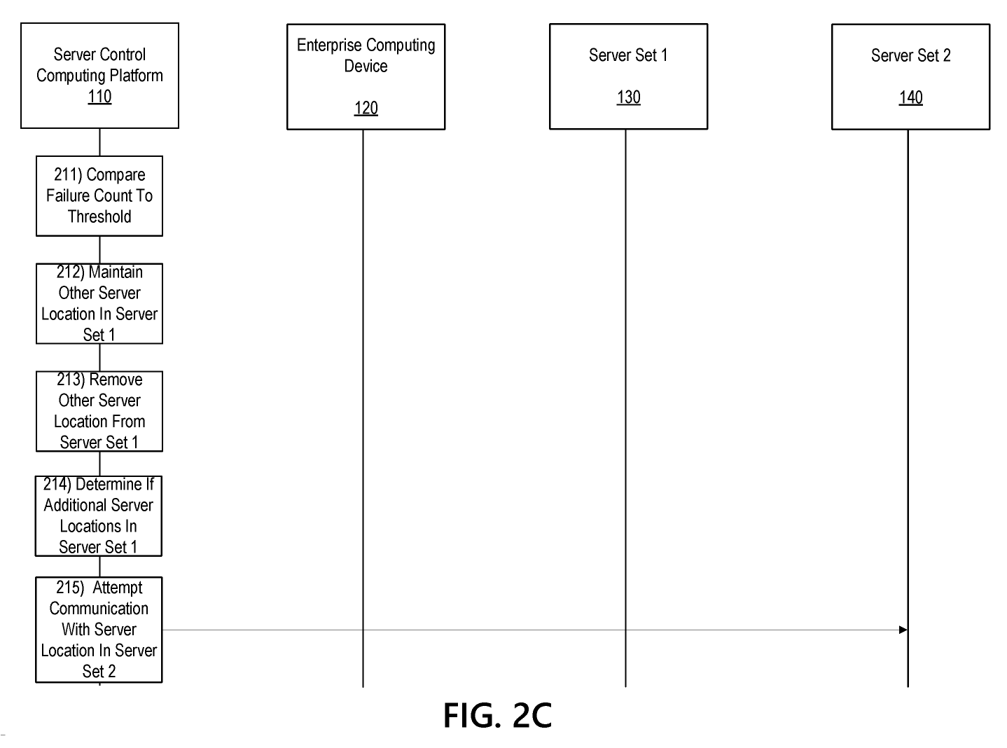

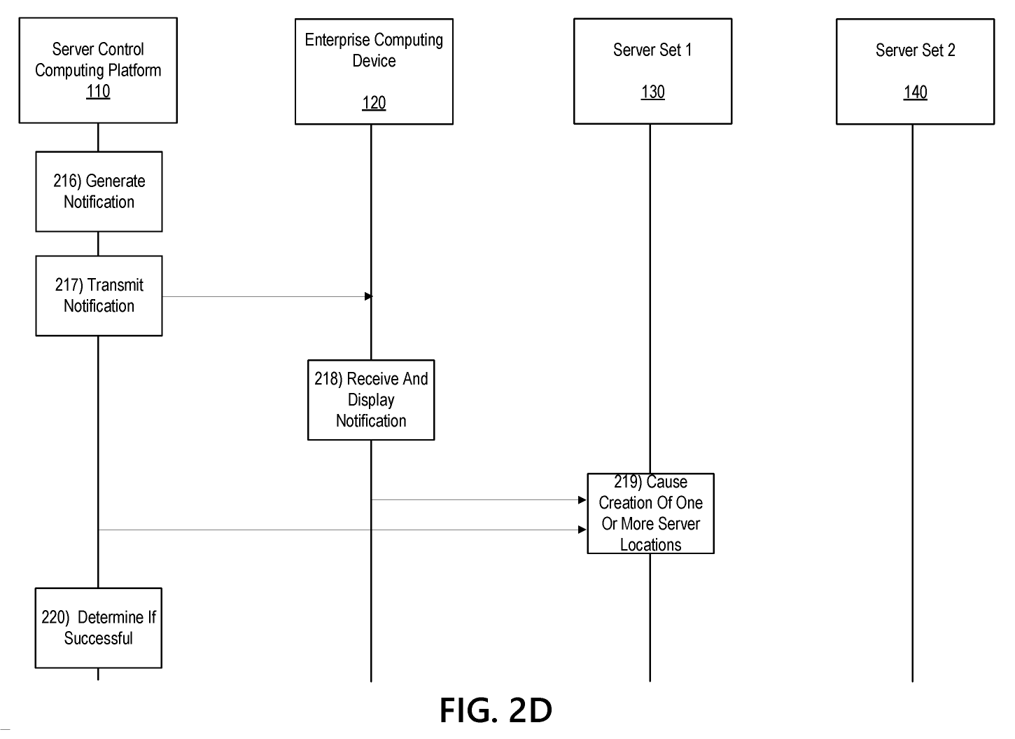

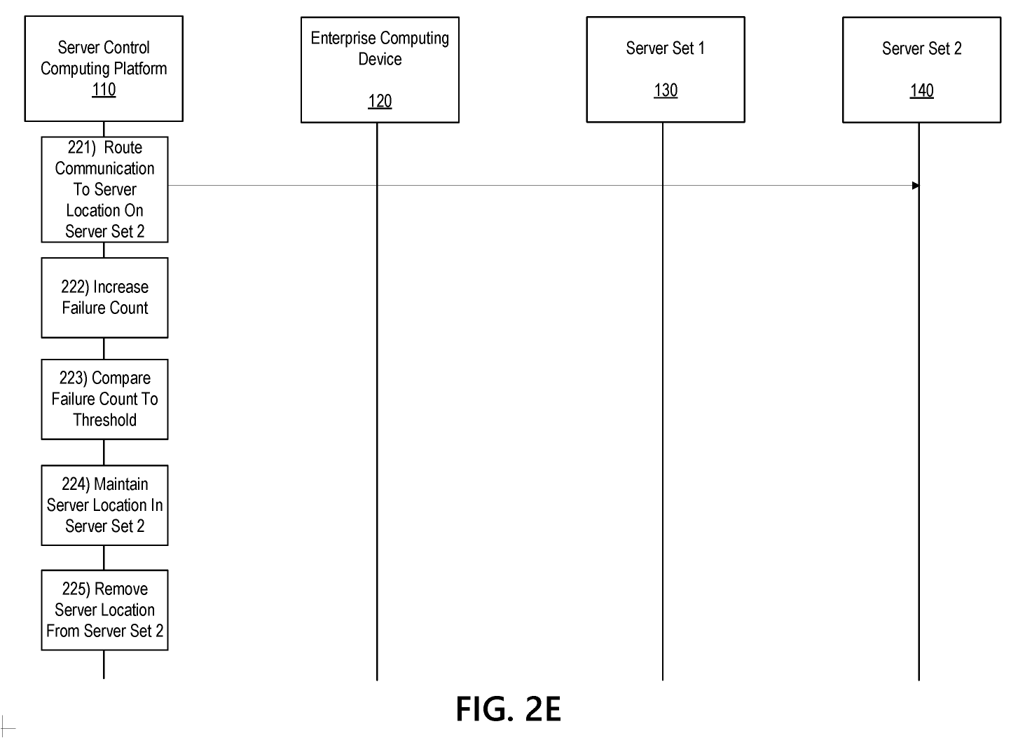

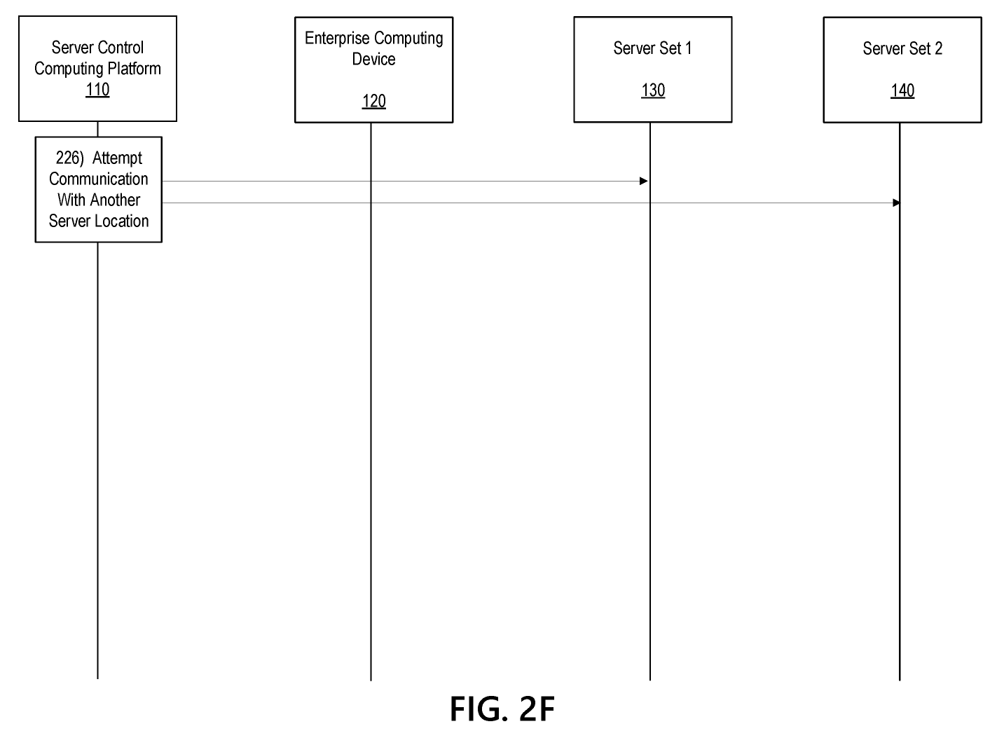

FIGS. 2A-2F depict one example illustrative event sequence for using server control to provide application resiliency in accordance with one or more aspects described herein. The events shown in the illustrative event sequence are merely one example sequence and additional events may be added, or events may be omitted, without departing from the invention. Further, one or more processes discussed with respect to FIGS. 2A-2F may be performed in real-time or near real-time.

With reference to FIG. 2A, at step 201, a client application, such as a client application executing on server control computing platform 110 or executing on another device in communication with server control computing platform 110 may attempt communication with a server location in server set 1 130. For instance, the communication may be attempted with server location 132a in server set 1 130.

At step 202, server control computing platform 110 may detect failure of the attempted communication.

At step 203, server control computing platform 110 may increase a failure count associated with the server location (e.g., server location 132a) in server set 1 130.

At step 204, server control computing platform 110 may compare the failure count for the server location (e.g., server location 132a) in server set 1 130 to a failure count threshold. The failure count threshold may be customized for an enterprise organization implementing the system. If, at step 204, the failure count for the server location (e.g., server location 132a) is below the failure count threshold, the server location (e.g., server location 132a) may be maintained in server set 1 130 at step 205.

With reference to FIG. 2B, if, at step 204, the failure count is at or above the failure count threshold, at step 206, the server location (e.g., server location 132a) may be removed from server set 1 130. In some examples, removing the server location may include disabling the server location by the server control computing platform 110, preventing attempted communication with the server location, and the like.

At step 207, in response to the failure to connect with the server location in server set 1 130, server control computing platform 110 may attempt to connect to another server location in server set 1 130. In some examples, server control computing platform 110 may randomly select the other server location to attempt communication with. Accordingly, the other server location may, in some instances, be a same server location with which communication was attempted in step 201 (e.g., server location 132a) or may be another server location (e.g., 132b, 132c or the like) in server set 1 130.

At step 208, server control computing platform 110 may determine whether the attempted communication with the other server location (e.g., server location 132b) in server set 1 130 was successful. If so, at step 209, the communication may be routed to the other server location (e.g., server location 132b) and the process may end.

If the attempted communication with the other server location (e.g., server location 132b) was not successful, at step 210, server control computing platform 110 may increase a failure count associated with the other server location (e.g., server location 132b).

With reference to FIG. 2C, at step 211, server control computing platform 110 may compare the failure count for the other server location (e.g., server location 132b) to the failure count threshold. If the failure count is below the threshold, at step 212, the other server location (e.g., server location 132b) may be maintained in server set 1 130.

If the failure count is at or above the failure count threshold, at step 213, the other server location (e.g., server location 132b) may be removed from server set 1 130. For instance, the other server location (e.g., server location 132b) might not be available for any further attempted communication.

At step 214, server control computing platform 110 may determine whether any server locations remain in server set 1 130. If so, the process may return to step 207 and attempt communication with another server location in server set 1 130. As discussed above with respect to step 207, the other server location may be randomly selected and may include one of the previously selected and failed server locations (e.g., server location 132a or server location 132b) or may be another server location (e.g., server location 132c) in server set 1 130.

At step 215, if no additional server locations remain in server set 1130, server control computing platform 110 may attempt communication with a server location in server set 2 140. For instance, server control computing platform 110 may attempt communication with server location 142a in server set 2 140.

At step 216, server control computing platform 110 may generate a notification indicating that no further server locations are available in server set 1 130 and that communication is being attempted with server locations in server set 2.

At step 217, server control computing platform 110 may transmit the notification to, for instance, enterprise computing device 120. Transmitting or sending the notification may cause the notification to be displayed by a display of enterprise computing device 120.

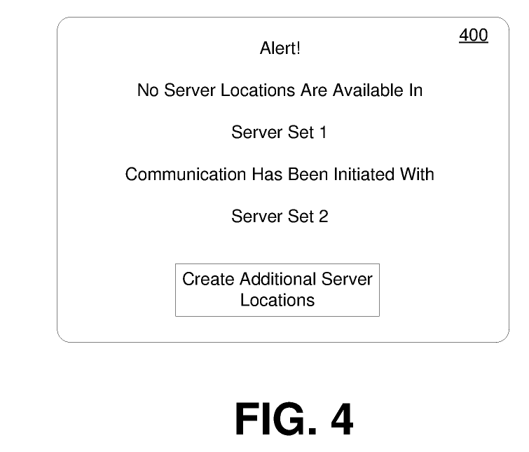

At step 218, enterprise computing device 120 may receive and display the notification. FIG. 4 illustrates one example notification that may be displayed. The notification 400 includes an indication that no further server locations are available in server set 1 130 and that communication is now being attempted with locations in server set 2 140. In some examples, the notification may include a selectable option to initiate creation of additional server locations in server set 1.

In some examples, if no additional server locations are created in server set 1 and no available server locations are available in server set 2, the process may move to server set 3 150 and an additional notification identifying communication with server set 3 150 may be generated and provided.

At step 219, in response to the notification, one or more additional server locations may be generated or created in server set 1 130. In some examples, the additional server locations may be automatically generated (e.g., by server control computing platform 110) or may be created or generated in response to user input from enterprise computing device 120.

In some examples, steps 216 through 219 may be initiated simultaneously or near simultaneously with performance of step 215 and the attempted communication with a server location in server set 2 140. Steps 216 through 219 may then be performed in parallel with steps 215, 220, and/or other steps associated with attempting communication with server set 2 140.

At step 220, server control computing platform 110 may determine whether the attempted communication with the server location (e.g., server locations 142a) in server set 2 140 was successful.

With reference to FIG. 2E, if the attempted communication was successful, at step 221, server control computing platform 110 may route the communication to the server location (e.g., server location 142a) in server set 2 140 and the process may end.

If the attempted communication was not successful, a failure count associated with server location 142a may be increased at step 222 and, at step 223, the failure count may be compared to a failure count threshold to determine whether the server location should remain active in server set 2 140.

If the failure count is below the threshold, the server location (e.g., server location 142a) may be maintained in server set 2 140 at step 224. If at or above the threshold, the server location (e.g., server location 142a) may be removed from server set 2 140 or otherwise made unavailable for communication.

With reference to FIG. 2F, at step 226, server control computing platform 110 may, in response to the communication attempt with server location 142a being unsuccessful, server control computing platform 110 may attempt communication with an additional server. In some examples, the additional server may be a server location in server set 2 140 (e.g., server location 142a, 142b, 142c, or the like). Alternatively, if additional server locations have been added to server set 1 130, server control computing platform 110 may return to server set 1 130 and attempt communication with one of the newly added server locations. The process may then continue as described herein.

Accordingly, by maintaining and/or adding server locations and server sets, the arrangements described herein may ensure resiliency in communications with client applications and may available communication failures and/or downtime.

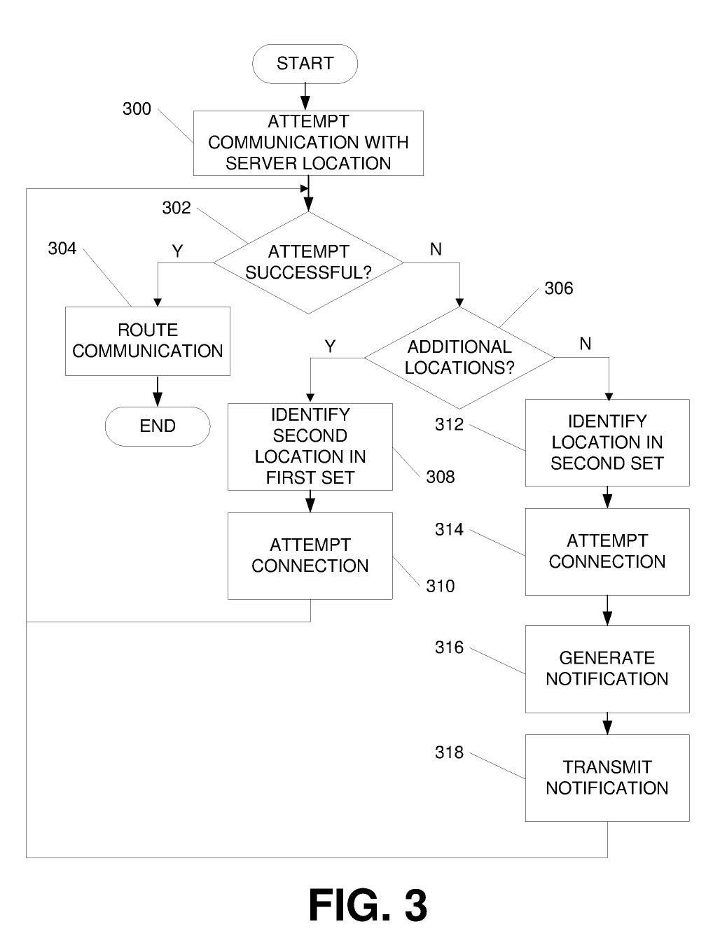

FIG. 3 is a flow chart illustrating one example method of providing resiliency in application communications in accordance with one or more aspects described herein. The processes illustrated in FIG. 3 are merely some example processes and functions. The steps shown may be performed in the order shown, in a different order, more steps may be added, or one or more steps may be omitted, without departing from the invention. In some examples, one or more steps may be performed simultaneously with other steps shown and described. One of more steps shown in FIG. 3 may be performed in real-time or near real-time.

At step 300, server control computing platform 110 may attempt to establish communication with server location of a plurality of server locations in a set of server locations. For instance, server control computing platform 110 may attempt to establish communication with a first server location of a plurality of server locations in a first set of server locations. In some examples, each server location may include a URL with which a client application is attempting to communicate/connect.

At step 302, server control computing platform 110 may determine whether the attempt to establish communication with the server was successful. For instance, server control computing platform 110 may determine whether the attempt to establish communication with the first server location of the plurality of server locations of the first set of server locations was successful. If so, at step 304, server control computing platform 110 may route the communication to the server location associated with the attempt (e.g., the first server location of the plurality of server locations in the first set of server locations) and the process may end.

If, at step 302, the attempt to establish communication was not successful, at step 306, server control computing platform 110 may determine whether additional locations within the set of server locations are available. For instance, server control computing platform 110 may determine whether additional server locations in the first set of server locations are available.

If so, at step 308, server control computing platform 110 may identify another location in the set of server locations. For instance, server control computing platform 110 may identify a second server location of the plurality of server locations in the first set of server locations. In some examples, the second server location may be randomly selected. In some arrangements, the second server location may be a same server location as the first server location (e.g., if available), while in other arrangements, the second server location may be a different server location from the first server location.

At step 310, server control computing platform 110 may attempt to establish communication with the identified second server location (e.g., the second server location of the plurality of server locations in the first set of server locations). The process may then return to step 302 to determine whether the attempt was successful. In some examples, prior to executing step 310 and attempting to establish communication with the identified second server location, server control computing platform 110 may execute a pause for a predetermined time period.

If, at step 306, additional server locations in the set of server locations are not available (e.g., server locations in the first set of server locations are not available), at step 312, server control computing platform 110 may identify a server location in another set of server locations. For instance, server control computing platform 110 may identify a server location of a plurality of server locations in a second set of server locations.

At step 314, server control computing platform 110 may attempt to establish communication with the server location of the plurality of server locations in the second set of server locations.

At step 316, server control computing platform 110 may generate a notification indicating that the attempt to establish communication with the server location of the plurality of server locations in the second set of server locations has been executed and providing an option to create additional server locations. In some examples, the option to create the additional server locations may include an option to create one or more additional server locations in the first set of server locations. In some arrangements, the option to create additional server locations may include an option to create one or more additional sets of server locations.

At step 318, server control computing platform 110 may transmit or send the notification to an enterprise computing device 120. In some examples, transmitting or sending the notification may cause the enterprise computing device 120 to display the notification on a display of enterprise computing device 120.

Accordingly, as discussed herein, aspects maintain communication for a client application by managing a number of server locations and server sets on an as-needed basis. Accordingly, computing resources may be conserved by creating server locations and/or server sets when needed, rather than in advance, to ensure that communication is maintained but that an abundance of resources are not established prior to use.

Aspects described herein may, in some examples, be used to maintain communication associated with client applications running in an environment internal to an enterprise organization implementing the arrangements described. Further, the arrangements described may be seamless and/or transparent to a user. For instance, a user associated with the client application attempting communication might not be aware of any issues with any server location as the system iterates through the available server locations to identify an available server location for communication, thereby improving the user experience.

Further, when communication is successful with a particular server location, the server control computing platform 110 may identify the successful server location, in some examples, as an available server location such that communication may be sent and received via that server location, other attempts to communicate may be made to that server location, or the like. Further, in some arrangements, additional software could be used in forwarding the network traffic through one or more other systems, to a server running within the enterprise organization, or the like. Accordingly, the communication does not have to be direct communication but rather than come from or sent to various sources (e.g., VPN, SSH tunnel, or the like). For instance, if an entity does not use web servers or web clients, but rather SSH key and tunnels, the arrangements described could be used to iterate through different keys and tunnels in a manner similar to the arrangements discussed above with respect to different server locations.

The arrangements described herein can be used in the context of URLs (e.g., server locations may include a URL) and/or IP addresses, host names, or the like without departing from the invention.

As discussed herein, the arrangements described are scalable for different types of enterprise organizations implementing the arrangements, for different types of client applications, or the like. Because new server locations can be added at any time, the application may continue to attempt communication without actually ever failing.

Further, while the arrangements described include removing a server location after a failure count threshold has been met, in some examples, if a server location being evaluated is in a last server set or is a last server location in a last server set, the system might not allow removal of the server location. In some examples, attempts to communicate may continue until additional server locations are created, additional sets of server locations are added, or the like. Thus, the system may prevent a final location and/or a final set from being removed from use until additional locations/sets are made available.

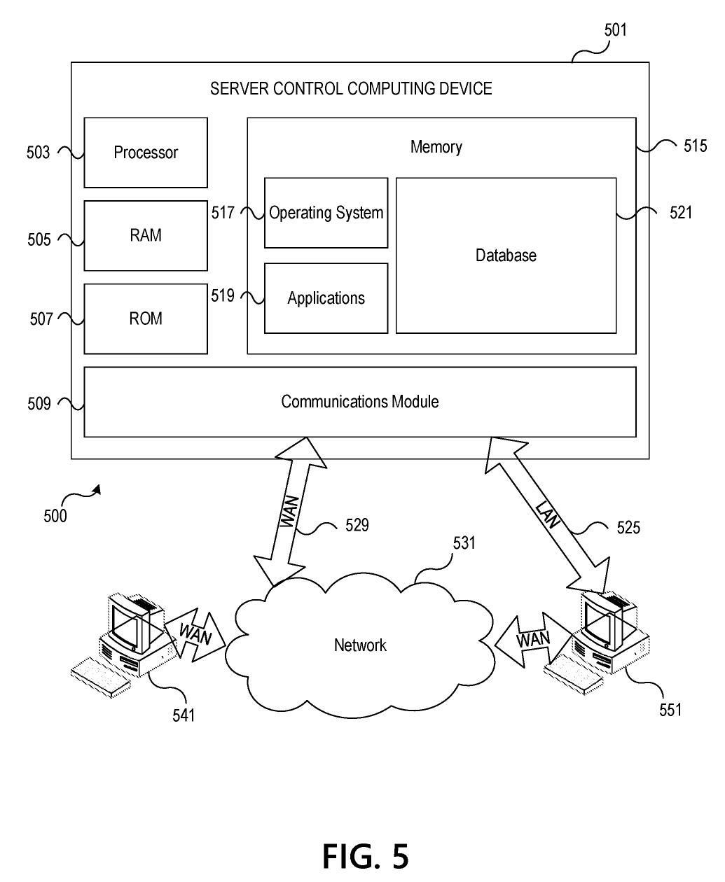

FIG. 5 depicts an illustrative operating environment in which various aspects of the present disclosure may be implemented in accordance with one or more example embodiments. Referring to FIG. 5, computing system environment 500 may be used according to one or more illustrative embodiments. Computing system environment 500 is only one example of a suitable computing environment and is not intended to suggest any limitation as to the scope of use or functionality contained in the disclosure. Computing system environment 500 should not be interpreted as having any dependency or requirement relating to any one or combination of components shown in illustrative computing system environment 500.

Computing system environment 500 may include server control computing device 501 having processor 503 for controlling overall operation of server control computing device 501 and its associated components, including Random Access Memory (RAM) 505, Read-Only Memory (ROM) 507, communications module 509, and memory 515. Server control computing device 501 may include a variety of computer readable media. Computer readable media may be any available media that may be accessed by server control computing device 501, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by server control computing device 501.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor (e.g., hardware processor) on server control computing device 501. Such a processor may execute computer-executable instructions stored on a computer-readable medium.

Software may be stored within memory 515 and/or storage to provide instructions to processor 503 for enabling server control computing device 501 to perform various functions as discussed herein. For example, memory 515 may store software used by server control computing device 501, such as operating system 517, application programs 519, and associated database 521. Also, some or all of the computer executable instructions for server control computing device 501 may be embodied in hardware or firmware. Although not shown, RAM 505 may include one or more applications representing the application data stored in RAM 505 while server control computing device 501 is on and corresponding software applications (e.g., software tasks) are running on server control computing device 501.

Communications module 509 may include a microphone, keypad, touch screen, and/or stylus through which a user of server control computing device 501 may provide input, and may also include one or more of a speaker for providing audio output and a video display device for providing textual, audiovisual and/or graphical output. Computing system environment 500 may also include optical scanners (not shown).

Server control computing device 501 may operate in a networked environment supporting connections to one or more remote computing devices, such as computing devices 541 and 551. Computing devices 541 and 551 may be personal computing devices or servers that include any or all of the elements described above relative to server control computing device 501.

The network connections depicted in FIG. 5 may include Local Area Network (LAN) 525 and Wide Area Network (WAN) 529, as well as other networks. When used in a LAN networking environment, server control computing device 501 may be connected to LAN 525 through a network interface or adapter in communications module 509. When used in a WAN networking environment, server control computing device 501 may include a modem in communications module 509 or other means for establishing communications over WAN 529, such as network 531 (e.g., public network, private network, Internet, intranet, and the like). The network connections shown are illustrative and other means of establishing a communications link between the computing devices may be used. Various well-known protocols such as Transmission Control Protocol / Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A computing platform, comprising:
at least one processor;
a communication interface communicatively coupled to the at least one processor; and
a memory storing computer-readable instructions that, when executed by the at least one processor, cause the computing platform to:
attempt to establish communication with a first server location, wherein the first server location is one of a plurality of server locations within a first set of server locations;
responsive to determining that the attempt to establish communication with the first server location has failed, determine whether additional server locations of the plurality of server locations within the first set of server locations are available;
responsive to determining that additional server locations of the plurality of server locations in the first set of server locations are available:
identify a second server location of the plurality of server locations in the first set of server locations; and
attempt to establish communication with the identified second server location of the plurality of server locations in the first set of server locations;
responsive to determining that additional server locations of the plurality of server locations in the first set of server locations are not available:
identify a server location of a plurality of server locations in a second set of server locations;
attempt to establish communication with the identified server location of the plurality of server locations in the second set of server locations;
generate a notification indicating that the attempt to establish communication with the identified server location of the plurality of server locations in the second set of server locations has been executed and providing an option to create additional server locations; and
transmit the notification to an enterprise computing device, wherein transmitting the notification causes the notification to be displayed by a display of the enterprise computing device.

2. The computing platform of claim 1, further including instructions that, when executed, cause the computing platform to:
responsive to determining that the attempt to establish communication with the first server location has failed:
increase a failure count associated with the first server location;
compare the failure count to a failure count threshold;
responsive to determining, based on the comparing, that the failure count is below the failure count threshold, maintaining the first server location in the first set of server locations; and
responsive to determining, based on the comparing, that the failure count is at or above the failure count threshold, removing the first server location from the first set of server locations.

3. The computing platform of claim 1, wherein identifying a second server location of the plurality of server locations in the first set of server locations includes randomly identifying the second server location.

4. The computing platform of claim 1, further including instructions that, when executed, cause the computing platform to:
prior to attempting to establish communication with the identified second server location of the plurality of server locations in the first set of server locations, execute a pause for a predetermined time period.

5. The computing platform of claim 1, wherein the option to create additional server locations includes an option to create additional server locations in the first set of server locations.

6. The computing platform of claim 1, wherein the option to create additional server locations includes an option to create an additional set of server locations.

7. The computing platform of claim 1, further including instructions that, when executed, cause the computing platform to:
receive, from the enterprise computing device and in response to the notification, a request to create additional server locations; and
responsive to receiving the request, create one or more additional server locations.

8. A method, comprising:
attempting, by a computing platform, the computing platform having at least one processor, and memory, to establish communication with a first server location, wherein the first server location is one of a plurality of server locations within a first set of server locations;
responsive to determining that the attempt to establish communication with the first server location has failed, determining, by the at least one processor, whether additional server locations of the plurality of server locations within the first set of server locations are available;
responsive to determining that additional server locations of the plurality of server locations in the first set of server locations are available:
identifying, by the at least one processor, a second server location of the plurality of server locations in the first set of server locations; and
attempting, by the at least one processor, to establish communication with the identified second server location of the plurality of server locations in the first set of server locations;
responsive to determining that additional server locations of the plurality of server locations in the first set of server locations are not available:
identifying, by the at least one processor, a server location of a plurality of server locations in a second set of server locations;
attempting, by the at least one processor, to establish communication with the identified server location of the plurality of server locations in the second set of server locations;
generating, by the at least one processor, a notification indicating that the attempt to establish communication with the identified server location of the plurality of server locations in the second set of server locations has been executed and providing an option to create additional server locations; and
transmitting, by the at least one processor, the notification to an enterprise computing device, wherein transmitting the notification causes the notification to be displayed by a display of the enterprise computing device.

9. The method of claim 8, further:
responsive to determining that the attempt to establish communication with the first server location has failed:
increasing, by the at least one processor, a failure count associated with the first server location;
comparing, by the at least one processor, the failure count to a failure count threshold;
responsive to determining, based on the comparing, that the failure count is below the failure count threshold, maintaining, by the at least one processor, the first server location in the first set of server locations; and
responsive to determining, based on the comparing, that the failure count is at or above the failure count threshold, removing, by the at least one processor, the first server location from the first set of server locations.

10. The method of claim 8, wherein identifying a second server location of the plurality of server locations in the first set of server locations includes randomly identifying the second server location.

11. The method of claim 8, further including:
prior to attempting to establish communication with the identified second server location of the plurality of server locations in the first set of server locations, executing, by the at least one processor, a pause for a predetermined time period.

12. The method of claim 8, wherein the option to create additional server locations includes an option to create additional server locations in the first set of server locations.

13. The method of claim 8, wherein the option to create additional server locations includes an option to create an additional set of server locations.

14. The method of claim 8, further including:
receiving, by the at least one processor and from the enterprise computing device and in response to the notification, a request to create additional server locations; and
responsive to receiving the request, creating, by the at least one processor, one or more additional server locations.

15. One or more non-transitory computer-readable media storing instructions that, when executed by a computing platform comprising at least one processor, memory, and a communication interface, cause the computing platform to:
attempt to establish communication with a first server location, wherein the first server location is one of a plurality of server locations within a first set of server locations;
responsive to determining that the attempt to establish communication with the first server location has failed, determine whether additional server locations of the plurality of server locations within the first set of server locations are available;
responsive to determining that additional server locations of the plurality of server locations in the first set of server locations are available:
identify a second server location of the plurality of server locations in the first set of server locations; and
attempt to establish communication with the identified second server location of the plurality of server locations in the first set of server locations;
responsive to determining that additional server locations of the plurality of server locations in the first set of server locations are not available:
identify a server location of a plurality of server locations in a second set of server locations;
attempt to establish communication with the identified server location of the plurality of server locations in the second set of server locations;
generate a notification indicating that the attempt to establish communication with the identified server location of the plurality of server locations in the second set of server locations has been executed and providing an option to create additional server locations; and
transmit the notification to an enterprise computing device, wherein transmitting the notification causes the notification to be displayed by a display of the enterprise computing device.

16. The one or more non-transitory computer-readable media of claim 15, further including instructions that, when executed, cause the computing platform to:
responsive to determining that the attempt to establish communication with the first server location has failed:
increase a failure count associated with the first server location;
compare the failure count to a failure count threshold;
responsive to determining, based on the comparing, that the failure count is below the failure count threshold, maintaining the first server location in the first set of server locations; and
responsive to determining, based on the comparing, that the failure count is at or above the failure count threshold, removing the first server location from the first set of server locations.

17. The one or more non-transitory computer-readable media of claim 15, wherein identifying a second server location of the plurality of server locations in the first set of server locations includes randomly identifying the second server location.

18. The one or more non-transitory computer-readable media of claim 15, further including instructions that, when executed, cause the computing platform to:
prior to attempting to establish communication with the identified second server location of the plurality of server locations in the first set of server locations, execute a pause for a predetermined time period.

19. The one or more non-transitory computer-readable media of claim 15, wherein the option to create additional server locations includes an option to create additional server locations in the first set of server locations.

20. The one or more non-transitory computer-readable media of claim 15, wherein the option to create additional server locations includes an option to create an additional set of server locations.
